(19) United States
(12) Patent Application Publication
(10) Pub. No.: US 2021/0372816 A1
(43) Pub. Date: Dec. 2, 2021

(54) CONTROL MAP INFORMATION EVALUATION DEVICE, CONTROL MAP INFORMATION EVALUATION METHOD, AND CONTROL PROGRAM

(71) Applicant: DENSO CORPORATION, Kariya-city (JP)

(72) Inventor: KENTARO NISHIDA, Kariya-city (JP)

(21) Appl. No.: 17/401,006

(22) Filed: Aug. 12, 2021

Related U.S. Application Data
(63) Continuation of application No. PCT/JP2020/002290, filed on Jan. 23, 2020.

(30) Foreign Application Priority Data
Feb. 14, 2019 (JP) 2019-024701

(51) Int. Cl. G01C 21/00; G08G 1/16; B60W 60/00

(52) U.S. Cl. CPC G01C 21/3885; B60W 2556/00; B60W 60/001; G08G 1/167

(57) ABSTRACT

A control map information evaluation method is provided that includes acquiring control map information in which additional information pieces of plural kinds are given to a target area on a map. The additional information pieces are map information used for travel control of a vehicle. The method further includes determining whether consistency is present or absent between the additional information pieces of two or more of the plural kinds given to the same target area. The method further includes determining reliability of at least one of the additional information pieces, depending on presence and absence of the consistency determined.

### CROSS REFERENCE TO RELATED APPLICATIONS

This application is a continuation application of PCT/JP2020/002290 filed on Jan. 23, 2020, which designated the U.S. and claims the benefit of priority from Japanese Patent Application No. 2019-024701 filed on Feb. 14, 2019. The entire disclosures all of the above applications are incorporated herein by reference.

### FIELD

The present disclosure relates to a control map information evaluation device, a control map information evaluation method, and a control program.

### BACKGROUND

For travel control such as autonomous driving of vehicles such as automobiles, there is known a technology of using high-precision map data which is more detailed than map data used for route guidance.

### SUMMARY

The present disclosure provides a control map information evaluation device, a control map information evaluation method, and a control program.

In an example of the present disclosure, a control map information evaluation device acquires control map information in which additional information pieces of plural kinds are given to a target area on a map. The control map information evaluation device determines whether consistency is present or absent between the additional information pieces of two or more of the plural kinds. The control map information evaluation device determines reliability of at least one of the additional information pieces, depending on presence and absence of the consistency determined.

In an example of the present disclosure, a control map information evaluation method acquires control map information in which additional information pieces of plural kinds are given to a target area on a map. The control map information evaluation method determines whether consistency is present or absent between the additional information pieces of two or more of the plural kinds. The control map information evaluation method determines reliability of at least one of the additional information pieces, depending on presence and absence of the consistency determined.

In an example of the present disclosure, a control program causes a computer to perform: acquiring control map information in which additional information pieces of plural kinds are given to a target area on a map; determining whether consistency is present or absent between the additional information pieces of two or more of the plural kinds; and determining reliability of at least one of the additional information pieces, depending on presence and absence of the consistency determined.

### BRIEF DESCRIPTION OF DRAWINGS

Objects, features, and advantages of the present disclosure will become more apparent from the following detailed description made with reference to the accompanying drawings. In the drawings:

FIG. 1 is a diagram showing an example of a schematic configuration of a vehicle system;

FIG. 2 is a diagram showing an example of a schematic configuration of a control device;

FIG. 3 is a diagram showing an example of a combination of additional information that can be used to determine consistency for a lane;

FIG. 4 is a flowchart showing an example of a flow of data provision-related processing in the control device; and

FIG. 5 is a diagram showing an example of a schematic configuration of the control device.

### DETAILED DESCRIPTION

For travel control such as autonomous driving of vehicles such as automobiles, there is known a technology of using high-precision map data which is more detailed than map data used for route guidance. For each object, the high-precision map data is given information indicating detailed contents about the object. For example, there is a technology of using, for the vehicle travel control, a detailed road shape more detailed than data used for guidance regarding vehicle travel. In the technology, curvatures, transverse cross slopes, and longitudinal cross slopes at points given at predetermined pitches are used as the detailed road shape.

When a map company provides the information given (hereafter, given information) for each object in the high-precision map data, there is a possibility that the given information having incorrect contents is provided due to a mistake. On the promise that the high-precision map data is used for the travel control of vehicles, it may be preferable that whether the given information is usable for the travel control of vehicles is determinable. Regarding the given information, it may be desirable to improve certainty of the given information by determining reliability based on a relationship of added information pieces of kinds, rather than determining reliability of a single added information piece alone.

It is an object of the present disclosure to provide a control map information evaluation device, a control map information evaluation method, and a control program that can determine whether additional information pieces which are given to control map information and which are map information used for travel control of a vehicle and indicating detailed object contents on a map are usable for the travel control of the vehicle.

A control map information evaluation device in an example of the present disclosure comprises: a control map information acquirer unit that acquires control map information in which additional information pieces of plural kinds are given to a target area on a map, the additional information pieces being map information used for travel control of a vehicle and indicating details of the target area; a consistency determiner unit that determines whether consistency is present or absent between the additional information pieces of two or more of the plural kinds given to the same target area, based on the additional information pieces included in the control map information acquired by the control map information acquirer unit; and a reliability determiner unit that determines reliability of at least one of the additional information pieces, depending on presence and absence of the consistency determined by the consistency determiner unit.

A control map information evaluation method in an example of the present disclosure comprises: acquiring control map information in which additional information pieces of plural kinds are given to a target area on a map, the additional information pieces being map information used for travel control of a vehicle and indicating details of the target area; determining whether consistency is present or absent between the additional information pieces of two or more of the plural kinds given to the same target area, based on the additional information pieces included in the control map information acquired; and determining reliability of at least one of the additional information pieces, depending on presence and absence of the consistency determined.

A control program in an example of the present disclosure causes a computer to perform: acquiring control map information in which additional information pieces of plural kinds are given to a target area on a map, the additional information pieces being map information used for travel control of a vehicle and indicating details of the target area; determining whether consistency is present or absent between the additional information pieces of two or more of the plural kinds given to the same target area, based on the additional information pieces included in the control map information acquired; and determining reliability of at least one of the additional information pieces, depending on presence and absence of the consistency determined.

According to these, it is determined whether consistency is present or absent between the additional information pieces of two or more kinds given to the same target area, based on the additional information pieces included in the acquired control map information. Since the additional information pieces are map information indicating the detailed contents of the target area on the map, no error in the additional information pieces is supposed to lead to the presence of the consistency between the additional information pieces of two or more kinds given to the same target area. Therefore, the reliability of one or more of the additional information piece is determinable depending on the presence and absence of the consistency between the additional information pieces of two or more kinds given to the same target area. Once the reliability of the additional information piece is determinable, whether the additional information piece is usable for the travel control the vehicle becomes determinable according to the reliability of the additional information piece. Therefore, it is possible to determine whether the additional information piece given to the control map information, which is map information used for vehicle travel control and indicating detailed object contents on the map, is usable for the travel control of the vehicle. Since the reliability of the additional information piece is determinable by determining whether the consistency between the additional information of two or more kinds given to the same target area is present or absent, it is possible to determine the reliability of the additional information piece without using information other than information included in the control map information.

Embodiments of the present disclosure will be described with reference to the drawings. For convenience of describing embodiments, the portions having the same functions as those used in the description so far may be designated by the same reference signs and the description thereof may be omitted. For the parts with the same reference signs, the description in other embodiments can be referred to.

### Embodiment 1

### Schematic Configuration of Vehicle System 1

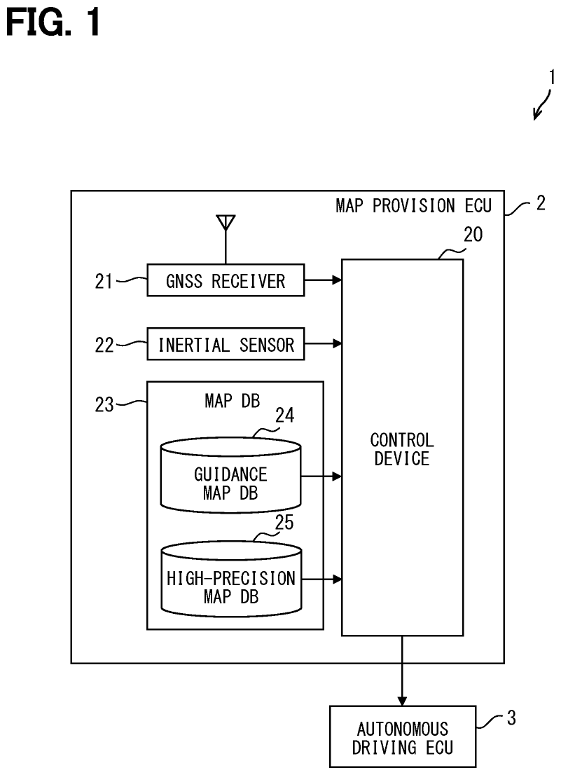

Hereinafter, Embodiment 1 of the present disclosure will be described with reference to the drawings. A vehicle system 1 shown in FIG. 1 is used in a vehicle such as an automobile, and includes a map provision ECU 2 and an autonomous driving ECU 3. The map provision ECU 2 and the autonomous driving ECU 3 may be connected to an in-vehicle LAN. Herein, the vehicle using the vehicle system 1 is referred to also as a subject vehicle.

The map provision ECU 2 is one of electronic control units mounted on the vehicle. The map provision ECU 2 successively outputs vehicle control data to the autonomous driving ECU 3. The vehicle control data includes position information of the subject vehicle, map information for vehicle control, sensed information regarding behavior of the subject vehicle, and the like. The details of the map provision ECU 2 will be described later.

The autonomous driving ECU 3 acquires the vehicle control data output from the map provision ECU 2. The autonomous driving ECU 3 recognizes a travel environment of the subject vehicle by using the acquired vehicle control data and results of sensing by surrounding monitoring sensors. As an example, a virtual space reproducing an actual travel environment in three dimensions is generated. The autonomous driving ECU 3 determines a travel plan of the subject vehicle based on the recognized travel environment and the sensed information regarding the behavior of the subject vehicle. As an example, executions of steering for lane keeping and lane change, acceleration and deceleration for speed adjustment, and sudden braking for collision avoidance are determined. The autonomous driving ECU 3 executes an autonomous driving function of performing travel control of the vehicle according to the determined travel plan, instead of a human driver performing a driving operation. The autonomous driving ECU 3 may be configured to perform travel control in cooperation with an ECU that controls the vehicle. The autonomous driving ECU 3 corresponds to a travel control device.

### Schematic Configuration of Map Provision ECU 2

Now, an example of the schematic configuration of the map provision ECU 2 will be described with reference to FIG. 1. As shown in FIG. 1, the map provision ECU 2 includes a control device 20, a global navigation satellite system (GNSS) receiver 21, an inertial sensor 22, and a map database (hereinafter, DB) 23. In the present embodiment, it is assumed that the control device 20, the GNSS receiver 21, the inertial sensor 22, and the map DB 23 are provided in a single casing.

The GNSS receiver 21 receives positioning signals from positioning satellites. The inertial sensor 22 includes, for example, a gyro sensor and an acceleration sensor. The gyro sensor successively detects an angular velocity of the subject vehicle around the vehicle vertical direction. The acceleration sensor detects accelerations of the subject vehicle in the vehicle longitudinal direction, the vehicle horizontal direction, and the vehicle vertical direction, respectively.

The map DB 23 includes a guidance map DB 24 and a high-precision map DB 25. The guidance map DB 24 stores guidance map information. The high-precision map DB 25 stores high-precision map information. The map DB 23 and the high-precision map DB 25 correspond to a control map storage unit. The high-precision map information corresponds to control map information. The guidance map DB 24 and the high-precision map DB 25 may be configured to use a non-volatile memory.

The guidance map information is map information used for a navigation function which provides route guidance. As an example, the map information for guidance is used to search for a recommended route to a destination and provide route guidance for the recommended route. The guidance map information can be paraphrased as map information for route guidance. The guidance map information is map information in which roads for vehicles to travel are represented by nodes, road links, and the like. The node is a point where a respective road on the map intersects, branches, or merges. The road links connect the nodes. The road links represent road segments. It is assumed that the road links represent segments per road, and do not represent segments per lane.

The high-precision map information is map information used for the travel control of the vehicle. The high-precision map information is more detailed map information than the guidance map information. The segments in the guidance map information represent the segments per road, whereas segments in the high-precision map information represent segments per lane. As the high-precision map information, additional information pieces of plural kinds, which are map information indicating the detailed contents of a target area on the map, are given to the target area.

The target area referred to herein may be a road segment or a lane segment (also called herein a lane link). In the following, the description will be given on assumption that the target area is a lane link. The additional information pieces includes lane shape information, width per lane (hereinafter, lane width), road width, geophysical object information, attribute information, and the like. The additional information pieces may be given for each lane link, or may be given for each point included in the lane link.

The lane shape information includes curvature, transverse cross slope, longitudinal cross slope, coordinates of a shape point group representing a line of lane center, and the like of the lane. The lane shape information, lane width, and road width correspond to physical values for a lane link. The geophysical object information includes information on class, type, shape, and color of a geophysical object. The classes of geophysical objects includes signs, traffic lights, lane markings, road markings, and the like. The types of geophysical objects include line types of lane markings, types of signs, types f road markings, and the like. The kinds and types of geophysical objects correspond to additional attributes indicating attributes of a lane link. Information on the shapes of geophysical objects include coordinates of shape points representing lane markings. The shape points representing the lane markings also correspond to physical values of a lane link. Information on the colors of the geophysical objects includes information on colors of lane markings.

The lane attribute information includes a connection relationship of lanes (that is, lane links). The connection relationship of lane links represents a connection relationship of lanes in the longitudinal direction of the road. The connection relationship of lane links is information given to the lane links adjacent to each other to indicate that the lane links are in a mutual connection relationship. The connection relationship of lane links corresponds to a link connection relationship.

The lane attribute information includes a branching merging attribute, a no-lane-marking section attribute, a lane increase decrease attribute, a lane change feasibility attribute, and the like. The lane attribute information corresponds to an additional attribute indicating the attribute of a lane link. The branching merging attribute is an attribute indicating that there is a branching or merging point where a road branching or merging occurs. The no-lane-marking section attribute is an attribute indicating that there is a no-lane-marking section. The no-lane-marking section referred to here is, in a road having two or more lanes for one direction, a section temporarily having no lane marking, wherein the road may have lanes for each of opposite directions. The section temporarily having no lane marking may occur due to an increase in road width at a road branching or merging point, or before or after a tollgate. The lane increase decrease attribute is an attribute indicating that there is a point where the number of lanes increases or decreases. The lane change feasibility attribute is an attribute indicating whether a lane change to an adjacent lane is feasible (in other others, permitted). The lane change feasibility attribute may be configured to include an attribute indicating whether the lane change to the left lane is feasible and an attribute indicating whether the lane change to the right lane is feasible.

The additional information pieces given in the high-precision map facilitates detailed recognition by the autonomous driving ECU of the travel environment. Therefore, because the recognizing of the travel environment in details by the autonomous driving ECU 3 is facilitated, the autonomous driving ECU 3 can perform more accurate travel control. In additional, the additional information pieces may reduce a processing load on the autonomous driving ECU 3 concerning determining, based on the sensing results of the surrounding monitoring sensors or the like, information equivalent to the additional information pieces. For example, the lane change feasibility attribute provided as the additional information piece makes it possible for the autonomous driving ECU 3 to determine whether a lane change is feasible in the current segment, without using an image captured by a camera to recognize the lane marking color.

The additional information pieces given to the high-precision map information is provided in advance by a map company. In this regard, there is a possibility that an incorrect additional information piece is provided to the high-precision map information due to a mistake made by the map company. Since the high-precision map information is used for the travel control of the vehicle, it may be preferable that whether the additional information pieces given to the high-precision map information are usable for the travel control of the vehicle is determinable. This is to reduce risk of providing erroneous information to the control system. To do so, a determination as to the additional information pieces is made for data reliability enhancement.

The control device 20 includes, for example, a processor, a memory, an I/O, and a bus connecting these, and executes processing related to provision of vehicle control data to the autonomous driving ECU 3 (hereinafter, data provision-related processing) by executing a control program stored in the memory. Executing this processing by a computer corresponds to executing a control map information evaluation method. The memory referred to here is a non-transitory tangible storage medium non-transitorily storing computer-readable program and data. The non-transitory tangible storage medium is implemented by a semiconductor memory, a magnetic disk, or the like. The control device 20 corresponds to a control map information evaluation device. The details of the control device 20 will be described below.

### Schematic Configuration of Control Device 20

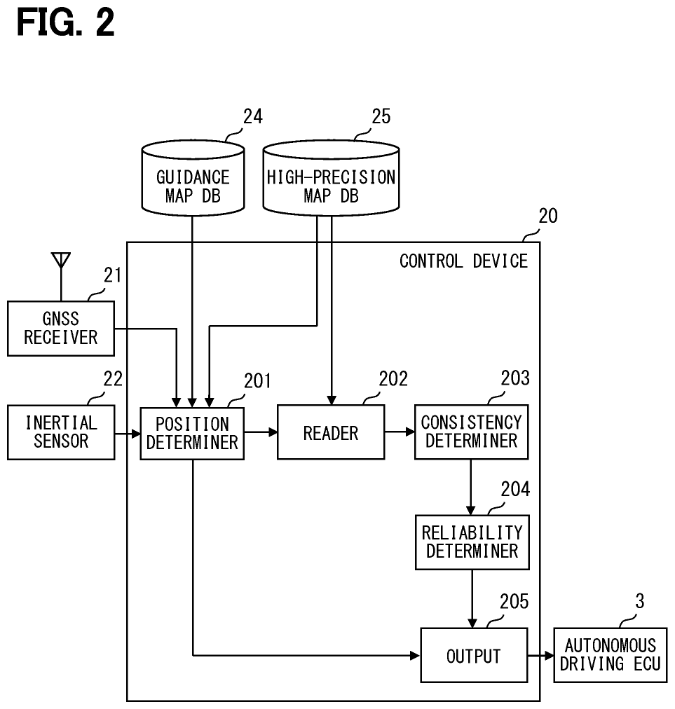

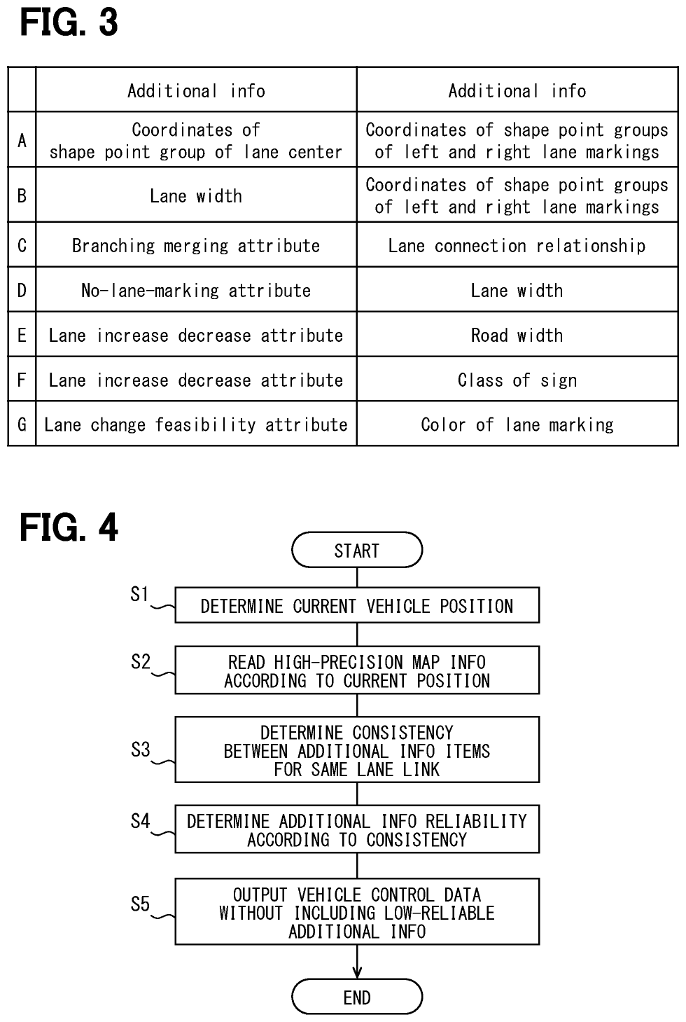

Next, using FIG. 2, the schematic configuration of the control device 20 will be described. As shown in FIG. 3, the control device 20 includes a position determiner unit 201, a reader unit 202, a consistency determiner unit 203, a reliability determiner unit 204, and an output unit 205 as functional blocks. Part or all of the functions executed by the control device 20 may be provided by hardware such as one or more ICs or the like. Part or all of the functional blocks included in the control device 20 may be implemented by a combination of a processor executing software and a hardware piece.

The position determiner unit 201 successively determines the current position of the subject vehicle. The position determiner unit 201 also determines the lane in which the subject vehicle is positioned. The position determiner unit 201 successively perform locating the subject vehicle by combining the positioning signals received by the GNSS receiver 21 and the sensing result of the inertial sensor 22. For example, the locating is performed at periods of 100 msec. The current position of the subject vehicle may be represented by, for example, coordinates of latitude, longitude, and altitude.

The position determiner unit 201 determines which road link the current position of the subject vehicle is on, by map matching. The map matching may be performed by using the trajectory of the position of the subject vehicle successively located, and the guidance map information stored in the guidance map DB 24. Further, the position determiner unit 201 determines which lane link the current position of the subject vehicle is on, by lane matching. The lane matching may be performed by using the trajectory of the position of the subject vehicle successively located and the high-precision map information stored in the high-precision map DB 25. Then, the position determiner unit 201 sends the determined current position of the subject vehicle and the sensing result of the inertial sensor 22 to the output unit 205.

The reader unit 202 reads, from the high-precision map DB 25, the high-precision map information of a given range corresponding to the current position determined by the position determiner unit 201. The reader unit 202 corresponds to a control map information acquirer unit. For example, the given range may range a road within a certain distance from the current position and the vicinity of the road. The reader unit 202 may be configured to read the high-precision map information each time the subject vehicle travels a certain distance, for example. The reader unit 202 may be configured to read the high-precision map information each time the position determiner unit 201 newly determines the current position.

The consistency determiner unit 203 determines whether consistency between the additional information pieces of two or more kinds given to the lane link being the same target area is present or absent, based on the additional information pieces included in the high-precision map information read by the reader unit 202. The consistency determiner unit 203 may be configured not to determine presence and absence of consistency for a lane link to which the additional information pieces of two or more kinds are not given. When a combination of the additional information pieces for which the consistency is determinable is absent among the additional information pieces of plural kinds given to a certain lane link, the consistency determiner unit 203 may not determine the presence nor absence of consistency for this lane link. When a combination of the additional information pieces for which the consistency is determinable is included in the additional information pieces of plural kinds given to a certain lane link, the consistency determiner unit 203 may determine whether consistency is present or absent for this lane link. In the following, some examples of the processing for consistency determination will be described with reference to FIG. 3. FIG. 3 is a diagram illustrating consistency determinable combinations of additional information pieces for a lane (that is, a lane link).

The consistency determiner unit 203 may determine whether consistency between the physical values of two or more kinds given to the same lane link is present or absent. For example, the consistency determiner unit 203 determines whether consistency is present or absent between the coordinates of the shape point group representing the lane center line and the coordinates of the shape point groups representing the left and right lane markings (see A in FIG. 3), wherein the coordinates of the shape point group representing the lane center line and the coordinates of the shape point groups representing the left and right lane markings are given to the same lane link. As an example, the trajectory corresponding to the lane center line and the trajectories corresponding to the left and right lane markings are obtained from the coordinates of the shape point groups. Then, when the lane center line is located inside the left and right lane markings, it is determined that the consistency is present. On the other hand, if the lane center line does not fall inside the left and right lane markings, it is determined that the consistency is absent.

The consistency determiner unit 203 determines whether consistency is present or absent between the lane width of a lane and a distance between the lane markings calculated from the coordinates of the shape point groups representing the left and right lane markings of the lane (see B in FIG. 3), wherein the lane width and the coordinates of the shape point groups representing the left and right lane markings are given to the same lane link. The distance between the lane markings may be calculated from the coordinates of the shape point groups representing the left and right lane markings. Then, when the lane width and the distance between the left and right lane markings are within a predetermined error range, it is determined that the consistency is present. On the other hand, if the lane width and the distance between the left and right lane markings are not within the predetermined error range, it is determined that there is no consistency.

It may be preferable that the consistency determiner unit 203 determine whether, at each change point at which the additional attribute on the map is changed, the consistency is present or absent between the lane width given to a lane link and the distance between the lane markings calculated from the coordinates of the shape point groups representing the left and right lane markings given to the lane link. The lane width does not change much. Therefore, determining the presence or absence of consistency for the lane width in a continuous fashion may increase unnecessary-processing load. On the other hand, determining the presence or absence of consistency for each change point at which the additional attribute is changed may reduce unnecessary-processing load as compared with determining the presence or absence of consistency for the lane width in a continuous fashion. Examples of the additional attribute described above include lane marking color, lane increase decrease attribute, and the like.

Determining whether consistency is present or absent between the physical values of two or more kinds given to the same lane link is not limited to the above examples. The consistency determination may be performed using other physical values that, when having no error, have consistency in relationship therebetween.

The consistency determiner unit 203 may determine whether consistency is present or absent between the additional attribute and the additional information piece of a kind different than the additional attribute, wherein the additional attribute and the additional information piece are given to the same lane link. In the above, it is assumed that the additional information piece of the kind (in other words, an additional information piece of a second kind) different from the additional attribute (in other words, an additional information piece of a first kind) includes no additional attribute.

The consistency determiner unit 203 may determine whether consistency is present or absent between the branching merging attribute and the connection relationship for the lane link (see C in FIG. 3), wherein the branching merging attribute and the connection relationship are given to the same lane link. As an example, when the branching merging attribute is given to a certain lane link and the connection relationship for the certain lane link is such that any of ends of the certain lane link is connected to a plurality of lane links, it is determined that the consistency is present. On the other hand, when the connection relationship for the certain lane link is such that both ends of the certain lane link are each connected to a single lane link, it is determined that the consistency is absent. This is because at the branching merging point of the road, the connection relationship should be such that at least one end of the lane link is connected to a plurality of lane links.

The consistency determiner unit 203 may determine presence or absence of consistency between the no-lane-marking section attribute and the road width given to the same lane link (see D in FIG. 3). As an example, when the no-lane-marking section attribute is given and the road width is equal to or more than a predetermined threshold, it is determined that the consistency is present. On the other hand, if the road width is less than the predetermined threshold, it is determined that there is no consistency. This is because, in the no-lane-marking section where the road width increases, the road width should increase. The threshold referred to here may be any suitable value as long as the threshold makes it possible to distinguish the increase in road width in the no-lane-marking section. As another example, when the no-lane-marking section attribute is added and the road width increases stepwise, it is determined that the consistency is present. On the other hand, when the road width does not increase stepwise, it is determined that the consistency is absent. This is because, in the no-lane-marking section where the road width increases, the road width should increase stepwise.

The consistency determiner unit 203 may determine whether consistency is present or absent between the lane increase decrease attribute and the road width (see E in FIG. 3), wherein the lane increase decrease attribute and the road width are given to the same lane link. As an example, when the lane increase decrease attribute is added and the road width increases or decreases stepwise, it is determined that the consistency is present. On the other hand, when the road width does not increase nor decrease stepwise, it is determined that there is no consistency. This is because when the number of lanes increases or decreases, the road width should increase or decrease stepwise. Determining whether the consistency is present or absent between the additional attribute and the additional information pieces of a kind different than the additional attribute given to the same lane link is not limited to the above examples. The consistency determination may be performed using other combinations of the additional attribute and the additional information piece of a kind different than the additional attribute when a relationship between the combination should be consistent.

The consistency determiner unit 203 may determine whether consistency is present or absent between the additional attributes of two or more kinds given to the same lane link. The consistency determiner unit 203 may determine whether consistency is present or absent between the lane increase decrease attribute and the sign class given to the same lane link (see E in FIG. 3). As an example, the lane increase decrease attribute indicates the decrease in the number of lanes is given and the sign class indicate the decrease in the number of lanes, it is determined that the consistency is present. On the other hand, if the sign class indicative of the decrease in the number of lanes is not given to the lane link, it is determined that there is no consistency.

The consistency determiner unit 203 may determine whether consistency is present or absent between the lane change feasibility attribute and the lane marking color given to the same lane link (see G in FIG. 3). As an example, when the lane change feasibility attribute indicates that a lane change to the left lane is feasible and the lane marking color on the left side of the lane is white, it is determined that the consistency is present. On the other hand, when the color of the lane marking on the left side of the lane is yellow, it is determined that there is no consistency. When the lane change feasibility attribute indicates that a lane change to the left lane is not feasible and the color of the lane marking on the left side of the lane is yellow, it is determined that the consistency is present. On the other hand, if the color of the lane marking on the left side of the lane is white, it is determined that the consistency is absent. The same applies to the lane change feasibility attribute indicative of the feasibility of the lane change to the right lane, by reversing the left and the right. Determining whether the consistency is present or absent between the additional attributes of two or more kinds given to the same lane link is not limited to the above examples. It may be performed using other combinations as long as the additional attributes are supposed to have a consistent relationship therebetween.

The reliability determiner unit 204 determines the reliability of the additional information piece, depending on the presence and absence of the consistency determined by the consistency determiner unit 203. As an example, it is determined that the additional information piece determined as inconsistent has low reliability. On the other hand, it is determined that the reliability of the additional information piece determined as consistent has high reliability. The reliability may be uniformly determined for two additional information pieces which is a combination of additional information pieces subject to the comparison in the consistency determination. Alternatively, the reliability may be determined for one of the two additional information pieces. For example, when it is determined whether the consistency is present or absent between the no-lane-marking section attribute and the road width, the reliability may be determined for both the no-lane-marking section attribute and the road width based on the presence or absence of the consistency, or the reliability may be determined only for the no-lane-marking section attribute.

The output unit 205 outputs vehicle control data to the autonomous driving ECU 3. The output unit 205 outputs, as the position information of the subject vehicle, the current position of the subject vehicle determined by the position determiner unit 201. The output unit 205 outputs the sensing result of the inertial sensor 22 as the sensing information regarding the behavior of the subject vehicle. The output unit 205 outputs the high-precision map information read by the reader unit 202 as the map information for vehicle control. Of the high-precision map information read by the reader unit 202, the output unit 205 does not output the additional information piece that is determined as having low reliability by the reliability determiner unit 204, assuming that the low reliable additional information piece is not usable for the travel control of the vehicle. Of the high-precision map information read by the reader unit 202, the output unit 205 outputs the additional information piece that is determined as having the high reliability by the reliability determiner unit 204, assuming that the high reliable information piece is usable for the travel control of the vehicle. That is, the output unit 205 switches between non-output and output of the additional information piece to the autonomous driving ECU 3 according to its reliability determined by the reliability determiner unit 204. The output unit 205 may or may not output the additional information piece for which consistency was not successfully determined. The output unit 205 may process the high-precision map information read by the reader unit 202 and thereafter output it.

### Data Provision-Related Processing in Control Device 20

Now, an example of the flow of data provision-related processing in the control device 20 will be described with reference to the flowchart of FIG. 4. The flowchart of FIG. 4 may be periodically executed while a switch for starting the internal combustion engine or the motor generator of the subject vehicle is in ON and the map provision ECU 2 is in the powered state.

First, in step S1, the position determiner unit 201 determines the current position of the subject vehicle. The determined current position of the subject vehicle includes on which lane link the current position is. In step S2, the reader unit 202 reads the high-precision map information of the given range corresponding to the current position determined in S1 from the high-precision map DB 25.

In step S3, the consistency determiner unit 203 determines whether the consistency is present or absent between the additional information pieces of two or more kinds given to the same lane link, based on the additional information pieces included in the high-precision map information read in S2. In step S4, the reliability determiner unit 204 determines the reliability of the additional information piece, depending on the presence and absence of the consistency determined in S3. In step S5, the output unit 205 outputs the vehicle control data to the autonomous driving ECU 3 such that the additional information piece determined as low reliable in S4 is not included in the output control data, and then the data provision-related processing is ended.

### Aspects of Embodiment 1

According to the configuration of Embodiment 1, the consistency determiner unit 203 determines whether consistency is present or absent between the additional information pieces of two or more kinds given to the same lane link, based on the additional information pieces included in the high-precision map information read and acquired from the high-precision map DB 25 by the reader unit 202. Since the additional information pieces are map information associated with a lane link and showing the details of the lane link, and thus, the consistency between the additional information pieces of two or more kinds given to the same lane link is supposed to exist as far as there is no error in the additional information pieces. Therefore, depending on presence or absence of the consistency between the additional information pieces of two or more kinds given to the same lane link, the reliability of the additional information piece is determinable. Therefore, the output unit 205 determines whether the additional information piece is usable for the travel control of the vehicle according to the reliability of the additional information piece, and accordingly, output of the low-reliability additional information piece to the autonomous driving ECU 3 is avoidable. That is, it is possible to reduce risk of providing an erroneous additional information piece to the autonomous driving ECU 3.

According to the configuration of Embodiment 1, the presence or absence of the consistency between the additional information pieces of two or more kinds added to the same lane link is determinable and accordingly the reliability of the additional information piece is determinable; therefore, the reliability of the additional information piece is determinable without using information other than the information included in the high-precision map information. Therefore, the reliability of the additional information piece is determinable inside the casing of the map provision ECU 2 without using information outside the map provision ECU 2.

### Embodiment 2

In Embodiment 1, whether or not the additional information piece is output to the autonomous driving ECU 3 depends on its reliability determined by the reliability determiner unit 204. However, the present disclosure is not limited to the above. As an example, Embodiment 2 employs such a configuration that the additional information piece is output to the autonomous driving ECU 3 regardless of its reliability. Hereinafter, the configuration of Embodiment 2 will be described. The vehicle system 1 of Embodiment 2 is the same as the vehicle system 1 of Embodiment 1 except that the map provision ECU 2 includes a control device 20a instead of the control device 20.

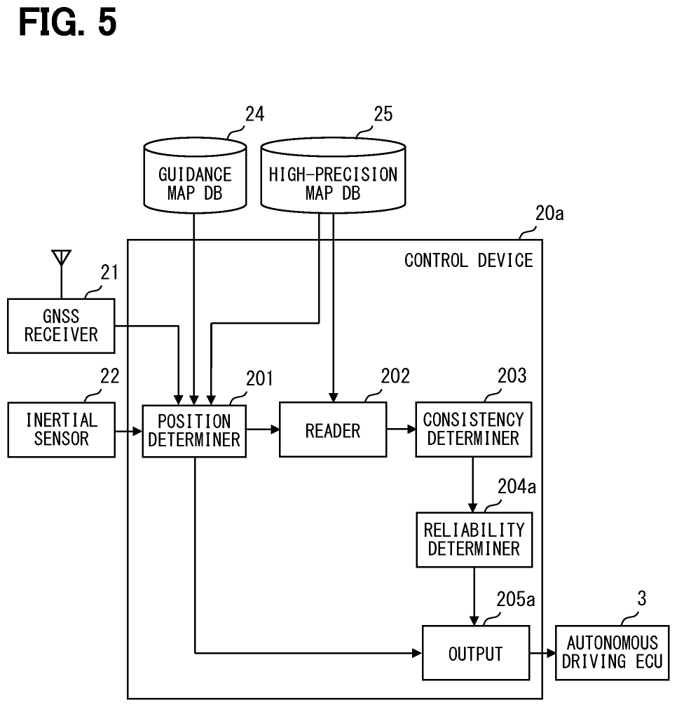

Now, a schematic configuration of the control device 20a will be described with reference to FIG. 5. As shown in FIG. 5, the control device 20a includes the position determiner unit 201, the reader unit 202, the consistency determiner unit 203, a reliability determiner unit 204a, and an output unit 205a as functional blocks. The control device 20a is the same as the control device 20 of Embodiment 1 except that the reliability determiner unit 204a and the output unit 205a are provided instead of the reliability determiner unit 204 and the output unit 205.

The reliability determiner unit 204a is the same as the reliability determiner unit 204 of Embodiment 1, except that the reliability determined for an additional information piece is added to this additional information piece. The reliability added to the additional information piece may be expressed as values indicating how high or low the reliability is in a stepwise manner. For example, the reliability determiner unit 204a may add the reliability “2” to the additional information piece determined as high reliable. The reliability determiner unit 204a may add the reliability “0” to the additional information piece determined as low reliable. The reliability determiner unit 204a may add, for example, the reliability “1” representing neither high reliability nor low reliability to the additional information piece for which the consistency determination by the consistency determiner unit 203 has not been successfully performed.

The output unit 205a is the same as the output unit 205 of Embodiment 1 except that an additional information piece is output regardless of the reliability determined for this additional information piece, and that the additional information piece added with the reliability is output. The reliability determiner unit 204a may add the reliability to the additional information pieces and the output unit 205a may output the additional information pieces added with the reliability.

The autonomous driving ECU 3 acquires the additional information pieces added with the reliability output from the output unit 205a. The autonomous driving ECU 3 may be configured not to use, for the travel control of the subject vehicle, the additional information piece added with the reliability that is less than a threshold. As an example configuration, the additional information piece added with the reliability less than 1 may not be used for the travel control of the subject vehicle.

According to the configuration of Embodiment 2, it is possible for the autonomous driving ECU 3 to determine whether the additional information piece is usable for the travel control of the vehicle according to the reliability of the additional information piece. As in the configuration of Embodiment 1, it is possible to determine the reliability of the additional information pieces without using information other than the information included in the high-precision map information.

### Embodiment 3

The above-described embodiments employ an example in which the target area is a lane link, but the present disclosure is not limited thereto. For example, the target area may be a road segment. In this case, the additional information pieces used include the road shape information, the road width, the geophysical object information, the attribute information, and the like. In this case, for example, the consistency determiner unit 203 may determine whether consistency is present or absent between the branching merging attribute and the connection relationship for the road link, wherein the branching merging attribute and the connection relationship for the road link are given to the same road segment. The target area may be a geophysical object or a predetermined range on the map.

### Embodiment 4

In the above-described embodiments, the map provision ECU 2 and the autonomous driving ECU 3 are separate from each other, but the present disclosure is not limited thereto. For example, the map provision ECU 2 and the autonomous driving ECU 3 may be integrated.

### Embodiment 5

For an additional information piece with the low reliability determined by the reliability determiner unit 204, 204a, information identifying the additional information piece may be uploaded, as probe information, to a center via a communication module. According to this configuration, the center can identify a problematic part of the map information and encourage the map company to correct the problematic part.

### Embodiment 6

In the above-described embodiment, the map provision ECU 2 includes the guidance map DB 24 and the high-precision map DB 25, but the present disclosure is not limited thereto. For example, the map provision ECU 2 may be configured not to include the guidance map DB 24 and/or the high-precision map DB 25. In this case, the reader unit 202 may be configured to download and acquire the guidance map information and/or the high-precision map information from a server or the like via a communication module.

Embodiments of the present disclosure are not limited to those illustrated above, and various modifications are possible. Embodiments obtained by appropriately combining technical elements disclosed in different embodiments are included in the spirit and scope of the present disclosure. The control devices and methods described in the present disclosure may be implemented by a special purpose computer created by configuring a memory and a processor programmed to execute one or more particular functions embodied in computer programs. Alternatively, the control devices and methods described in the present disclosure may be implemented by a special purpose computer created by configuring a processor provided by one or more special purpose hardware logic circuits. Alternatively, the control devices and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

What is claimed is:

1. A control map information evaluation device comprising:
a control map information acquirer unit that acquires control map information in which additional information pieces of plural kinds are given to a target area on a map, the additional information pieces being map information used for travel control of a vehicle and indicating details of the target area;
a consistency determiner unit that determines whether consistency is present or absent between the additional information pieces of two or more of the plural kinds given to the same target area, based on the additional information pieces included in the control map information acquired by the control map information acquirer unit; and
a reliability determiner unit that determines reliability of at least one of the additional information pieces, depending on presence and absence of the consistency determined by the consistency determiner unit.

2. The control map information evaluation device according to claim 1, wherein:
the additional information pieces of the plural kinds include physical values for the target area; and
the consistency determiner unit determines whether consistency is present or absent between the physical values of two or more kinds given to the same target area.

3. The control map information evaluation device according to claim 2, wherein:
the additional information pieces of the plural kinds include coordinates of a shape point group representing a lane center line and coordinates of shape point groups representing left and right lane markings, as the physical values for the target area;
the consistency determiner unit determines whether consistency is present or absent between the coordinates of the shape point group representing the lane center line and the coordinates of the shape point groups representing the left and right lane markings, wherein the coordinates of the shape point group representing the lane center line and the coordinates of the shape point group representing the left and right lane markings are given to the same target area; and
depending on presence and absence of the consistency determined by the consistency determiner unit, the reliability determiner unit determines reliability of the coordinates of the shape point group representing the lane center line included in the additional information pieces.

4. The control map information evaluation device according to claim 2, wherein:
as the physical values for the target area, the additional information pieces of the plural kinds include a lane width of a respective lane and the coordinates of the shape point groups representing the left and right lane markings of the respective lane;
the consistency determiner unit determines whether consistency is present or absent between the lane width and a distance between the lane markings calculated from the coordinates of the shape point groups representing the left and right lane markings, wherein the lane width and the coordinates of the shape point groups representing the left and right lane markings are given to the same target area; and
depending on presence and absence of the consistency determined by the consistency determiner unit, the reliability determiner unit determines reliability of the lane width included in the additional information pieces.

5. The control map information evaluation device according to claim 4, wherein:
the additional information pieces of the plural kinds include an additional attribute indicating an attribute of the target area; and
the consistency determiner unit determines whether, at each change point at which the additional attribute is changed, consistency is present or absent between the lane width and the distance between the lane markings calculated from the coordinates of the shape point groups representing the left and right lane markings.

6. The control map information evaluation device according to claim 1, wherein:
the additional information pieces of the plural kinds include an additional attribute indicating an attribute of the target area;
the additional attribute is the additional information piece of a first kind;
the additional information pieces of the plural kinds include the additional information piece of a second kind different from the first kind;
the consistency determiner unit determines whether consistency is present or absent between the additional information piece of the first kind and the additional information piece of the second kind given to the same target area; and
the reliability determiner unit determines reliability of the additional attribute depending on presence and absence of the consistency determined by the consistency determiner unit.

7. The control map information evaluation device according to claim 6, wherein:
the additional information pieces of the plural kinds include, as the additional attribute, a link connection relationship indicating a connection relationship of a road link or a lane link, and a branching merging attribute indicating road branching or road merging or lane branching or lane merging;
the consistency determiner unit determines whether consistency is present or absent between the branching merging attribute and the link connection relationship given to the same target area; and
the reliability determiner unit determines reliability of the branching merging attribute included in the additional information pieces, depending on presence and absence of the consistency determined by the consistency determiner unit.

8. The control map information evaluation device according to claim 6, wherein:
the additional information pieces of the plural kinds include a road width as a physical value for the target area, and a no-lane-marking section attribute indicating a no-lane-marking section as the additional attribute;
the consistency determiner unit determines whether consistency is present or absent between the no-lane-marking section attribute and the road width given to the same target area; and
the reliability determiner unit determines reliability of the no-lane-marking section attribute included in the additional information pieces, depending on presence and absence of the consistency determined by the consistency determiner unit.

9. The control map information evaluation device according to claim 6, wherein:
the additional information pieces of the plural kinds include a road width as a physical value for the target area, and a lane increase decrease attribute indicating an increase or decrease in the number of lanes as the additional attribute;
the consistency determiner unit determines whether consistency is present or absent between the lane increase decrease attribute and the road width given to the same target area; and
the reliability determiner unit determines reliability of the lane increase decrease attribute included in the additional information pieces, depending on presence and absence of the consistency determined by the consistency determiner unit.

10. The control map information evaluation device according to claim 1, wherein:
the additional information pieces of the plural kinds include additional attributes of a plurality of kinds indicating attributes of the target area; and
the consistency determiner unit determines whether consistency is present or absent between the additional attributes of the plurality of kinds given to the same target area.

11. The control map information evaluation device according to claim 10, wherein:
the additional attributes included in the additional information pieces of the plural kinds include: a sign class indicating class of a sign; and a lane increase decrease attribute indicating an increase or decrease in the number of lanes;
the consistency determiner unit determines whether consistency is present or absent between the lane increase decrease attribute and the sign class given to the same target area; and
the reliability determiner unit determines reliability of the lane increase decrease attribute included in the additional information pieces, depending on presence and absence of the consistency determined by the consistency determiner unit.

12. The control map information evaluation device according to claim 10, wherein:
the additional attributes included in the additional information pieces of the plural kinds include lane marking color; and a lane change feasibility attribute indicating whether a lane change is feasible;
the consistency determiner unit determines whether consistency is present or absent between the lane change feasibility attribute and the lane marking color given to the same target area; and
the reliability determiner unit determines reliability of the lane change feasibility attribute depending on presence and absence of the consistency determined by the consistency determiner unit.

13. The control map information evaluation device according to claim 1, further comprising:
an output unit that outputs one or more of the additional information pieces to a travel control device that performs travel control of the vehicle, wherein:
for outputting one or more of the additional information pieces to the travel control device, the output unit adds the reliability of the one or more of the additional information pieces determined by the reliability determiner unit to the one or more of the additional information pieces and outputs the one or more of the additional information pieces added with reliability.

14. The control map information evaluation device according to claim 1, further comprising:
an output unit that outputs one or more of the additional information pieces to a travel control device that performs travel control of the vehicle, wherein
the output unit switches between non-output and output of one or more of the additional information pieces to the travel control device according to the reliability determined by the reliability determiner unit.

15. A control map information evaluation method performed by a computer, comprising:
acquiring control map information in which additional information pieces of plural kinds are given to a target area on a map, the additional information pieces being map information used for travel control of a vehicle and indicating details of the target area;
determining whether consistency is present or absent between the additional information pieces of two or more of the plural kinds given to the same target area, based on the additional information pieces included in the control map information acquired; and
determining reliability of at least one of the additional information pieces, depending on presence and absence of the consistency determined.

16. A non-transitory storage medium storing a control program causing a computer to perform:
acquiring control map information in which additional information pieces of plural kinds are given to a target area on a map, the additional information pieces being map information used for travel control of a vehicle and indicating details of the target area;
determining whether consistency is present or absent between the additional information pieces of two or more of the plural kinds given to the same target area, based on the additional information pieces included in the control map information acquired; and
determining reliability of at least one of the additional information pieces, depending on presence and absence of the consistency determined.
